(19) United States
(12) Patent Application Publication
(10) Pub. No.: US 2011/0253687 A1
(43) Pub. Date: Oct. 20, 2011

(54) MOUTH OF A HOOD FOR SUCKING UP FINE PARTICLES, AND LASER DEVICE FOR ABLATING A SURFACE LAYER OF A WALL COMPRISING SUCH A HOOD

(75) Inventors: Francois Champonnois, Bures Sur Yvette (FR); Yves Lecoffre, La Tronche (FR)

(73) Assignee: Commissariat A L'Energie Atomique Et Aux Energies Alternatives, Paris (FR)

(21) Appl. No.: 13/141,772

(22) PCT Filed: Dec. 23, 2009
(86) PCT No.: PCT/EP2009/067892

§ 371 Date: Jun. 23, 2011

(30) Foreign Application Priority Data
Dec. 23, 2008 (FR) 0859043

(51) Int. Cl. B23K 26/00; A47L 9/00

(52) U.S. Cl. 219/121.67; 15/300.1

(57) ABSTRACT

The invention relates to a hood for sucking up fine particles, comprising: an air intake mouth comprising a crest intended to be placed close to a wall or to emit fine particles, the crest defining an internal portion of the hood and an external portion; and a suction outlet intended to suck up the fine particles. The hood is characterized in that the mouth further includes an external lip extending towards the suction outlet and having a leading edge located on the same side as the outlet in relation to the crest, so that, when the hood is in operation, the sucked-up air undergoes no separation at the lip and that an air separation zone is located only in the internal portion of the hood.

### GENERAL TECHNICAL FIELD

The invention relates to a hood for sucking up fine particles, in particular used in a device for the laser ablation of a surface layer of a wall such as a wall covering of paint, for example in a nuclear facility.

### PRIOR ART

Decontaminating and cleaning up nuclear facilities that have become obsolete or that have reached their age limit have become a priority for the nuclear industry. The contaminated parts of these facilities must be cleaned, avoiding the production of waste that is also contaminated and striving to minimise the cleaning effluents.

A known solution for carrying out the decontamination of nuclear facilities consists in using laser ablation.

Document FR 2 887 161 describes a laser ablation device for ablating a layer of wall paint to be decontaminated, for example in a nuclear facility. FIG. 1 shows such a device.

Such a device comprises a frame 10 whereon is mounted at least one laser source 4b, an optical deflector 4 mounted downstream of the laser source 4b in order to receive the laser beams 6. The optical deflector 4 comprises at its outlet a deflection head 4a comprising an objective lens 4c to focus the laser beams 6 onto a layer 2 to be ablated.

The laser ablation consists in removing a layer of reduced thickness of the contaminating material to be removed, via the interaction of focused laser beams coming from the laser source 4b with this material. During the impact of the laser, the material disintegrates and particles of highly varied dimensions are created, with the finest particles having a characteristic dimension much less than a micron.

As the particles are contaminated, in order to prevent them from propagating in the atmosphere a hood is provided comprising an air intake mouth 30 comprising a crest 3b that is placed close to the wall 2. The crest 3b defines an internal portion 31 and an external portion 32 (see also FIGS. 2a and 2b).

Crest 3b means all of the points of the mouth located on the same side or altitude in order to form an apex on the mouth. The crest 3b is as such all of the points of the mouth 30 located the closest to the wall 2, in operation, as explained in what follows.

The hood further comprises a suction outlet 5 to suck up the particles.

The hood 1 is applied close to the wall 2 as shown in FIG. 1. Air 8 enters the hood via the mouth 30. The air 8 is loaded with particles produced by the laser and this air 9, loaded with particles, is evacuated through the suction outlet 5a.

The known hood has disadvantages.

FIG. 2a shows a detailed view of a known mouth 30.

The mouth 30 comprises a leading edge A of which the angle is sharp. Such a leading edge A causes an air separation 21 which moves away from the surface of the mouth, generating a turbulent flow of the air 8, which creates vortices 22 of air at the mouth.

Due to the vortices 22, contaminated particles can be deposited on the crest 3b of the mouth 30. These deposited particles can then escape from the hood during a later handling of the latter.

In addition, the vortices 22 can repel towards the exterior 32 of the hood contaminated particles that are about to be sucked.

### PRESENTATION OF THE INVENTION

The invention makes it possible to avoid at least one of the aforementioned disadvantages.

As such, according to a first aspect, the invention relates to a hood for sucking up fine particles, comprising: an air intake mouth comprising a crest intended to be placed close to a wall able to emit fine particles, the crest defining an internal portion of the hood and an external portion; and a suction outlet intended to suck up the fine particles.

The hood of the invention is characterised in that the mouth further comprises an external lip extending towards the suction outlet and comprising a leading edge located on the same side as the outlet in relation to the crest, in such a way that, when the hood is in operation, the sucked-up air undergoes no separation at the lip and that an air separation zone is located only in the internal portion of the hood.

The hood of the invention can furthermore optionally have at least one of the following characteristics:
when the hood is in operation, the lip forms, in combination with the wall, a progressive convergent of the leading edge towards the crest;
the lip has a curved profile, more preferably parabolic;
the mouth further comprises an internal shoulder able to form a vortex trap beyond the crest in the separation zone, in such a way that, when the hood is in operation, the vortices remain inside the hood in relation to the wall;
the mouth comprises means for positioning the hood in relation to the wall in order to allow for the adjustment of a distance between the crest and the wall;
the means for positioning comprise stop screws on the wall;

it further comprises a base comprising a porthole that is able to allow a laser beam to pass through and an intermediary portion between the mouth and the base;
the intermediary portion is convergent between the mouth and the base.

And according to a second aspect, the invention relates to a laser ablation device of a surface layer of a wall comprising a hood for sucking up fine particles according to the first aspect of the invention.

As such, the invention prevents contaminated particles from exiting the hood, because the possible vortices cannot repel the particles towards the exterior of the hood, in operation, but also because the possible particle deposits of particles are located in the internal portion of the hood, and therefore can easily be controlled during later manipulations.

### PRESENTATION OF THE FIGURES

Other characteristics and advantages of the invention shall appear in the following description, which is purely for the purposes of illustration and is not limited, and must be read with regards to the annexed figures wherein, in addition to FIGS. 1 and 2 already discussed:

FIGS. 3a and 3b show respectively a view according to a straight section of the mouth of the hood according to the invention and a top view;

FIGS. 4a and 4b show respectively a view according to a straight section and a top view of the mouth of an alternative of the mouth of the hood according to the invention;

FIG. 5 shows means for positioning the mouth of the hood according to the invention in relation to a wall to be decontaminated.

In all of the figures, similar elements bear identical reference numbers.

### DETAILED DESCRIPTION

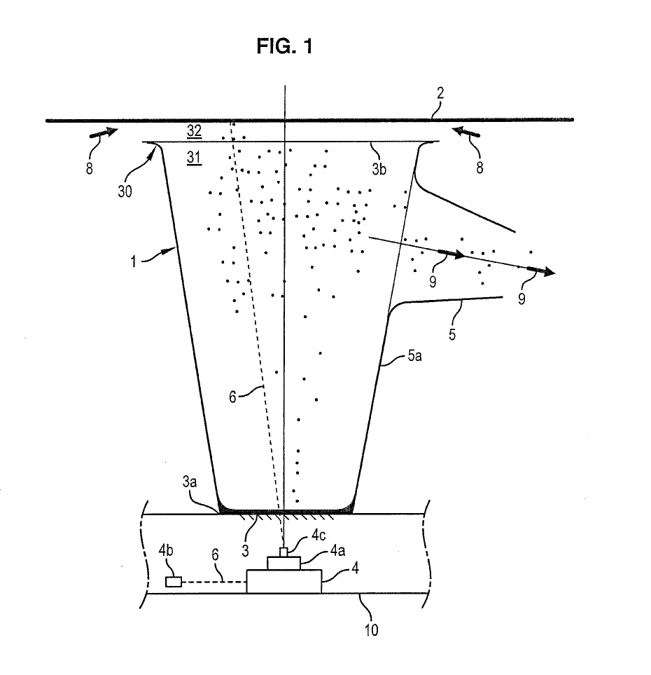

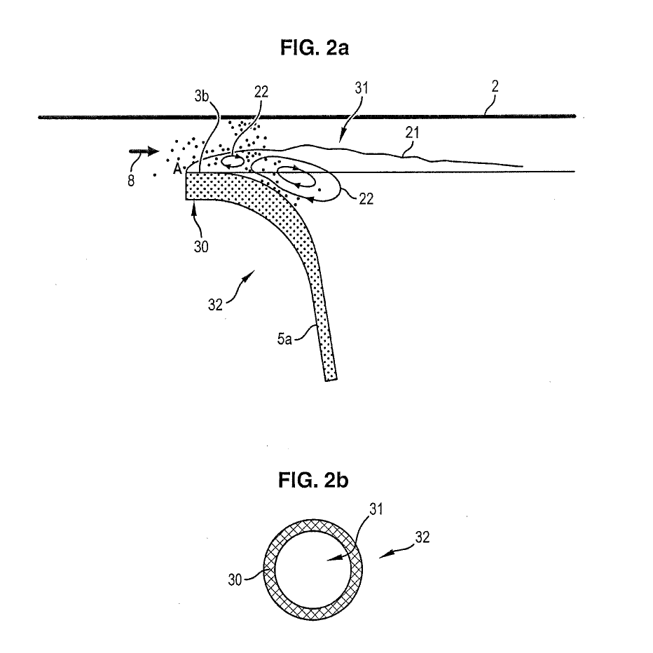

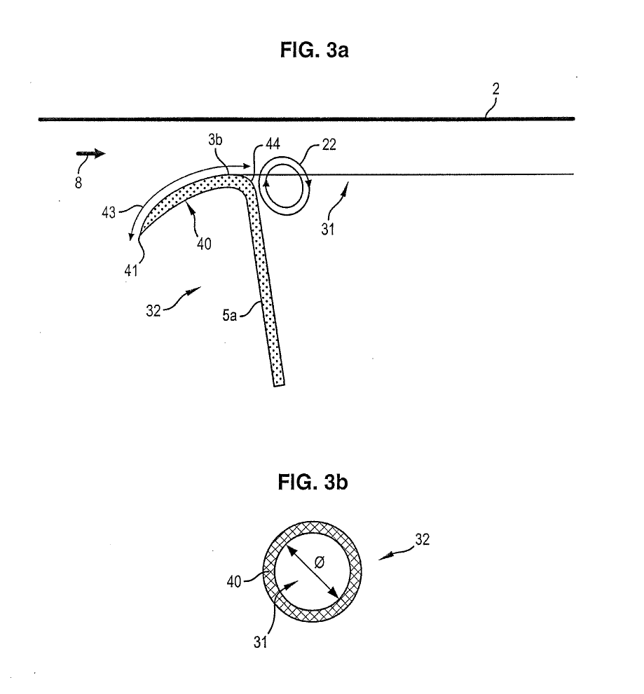

A hood for sucking up fine particles comprises, as shown in FIG. 1, an air intake mouth 30 comprising a crest 3b intended to be arranged close to a wall 2 able to emit fine particles. The crest 3b defines an internal portion 31 of the hood and an external portion (see FIG. 3b). The crest 3b is part of the external portion 32 of the hood.

The hood further comprises a suction outlet 5 intended to suck up the fine particles (see FIG. 1).

FIGS. 3a and 3b show a straight cross-section view and a top view of the mouth of a hood which prevents contaminated particles from exiting from the latter.

The hood comprises in particular an external lip 40—the lip belongs to the external portion 32 of the hood—extending towards the suction outlet 5 and comprising a leading edge 41 located on the same side as the suction outlet 5 in relation to the crest 3b.

Such a lip 40 makes it possible, when the hood is in operation, for the sucked-up air 8 to undergo no air separation starting from the profile, and that the flow not be turbulent at the lip 40.

When the hood is in operation, the lip 40 forms as such, in combination with the wall 2, a progressive convergent of the leading edge 41 towards the crest 3b. There is no air separation starting from the lip 40 in the external portion 32, as there is a progressive shrinking of the section of passage of the flow of air between the external portion 32 and the crest 3b.

An air separation zone is located only in the internal portion 31 of the hood, as can be seen in FIG. 3a for example. In other terms, the air 8 entering the hood follows the lip 40 as shown by the arrow 43, and undergoes a turbulent separation from the hood only once it has entered the internal portion 31 of the hood. The fact that the separation zone is located only in the internal portion 31 provides a dynamic confinement of vortices 22, generated by the air separation, in the internal portion 31.

Indeed, contrary to the mouth 30 shown in FIGS. 2a and 2b, there is no sharp angle which generates a separation before the air 8 enters the hood. The air 8 enters the hood by following the lip 40 which forms a progressive convergent between the leading edge 41 and the crest 3b.

Preferentially, the lip 40 has a curved profile, of which the straight section can advantageously be of parabolic section. As shown in FIG. 3a in particular, the convex side of the curved profile is directed towards the wall 2.

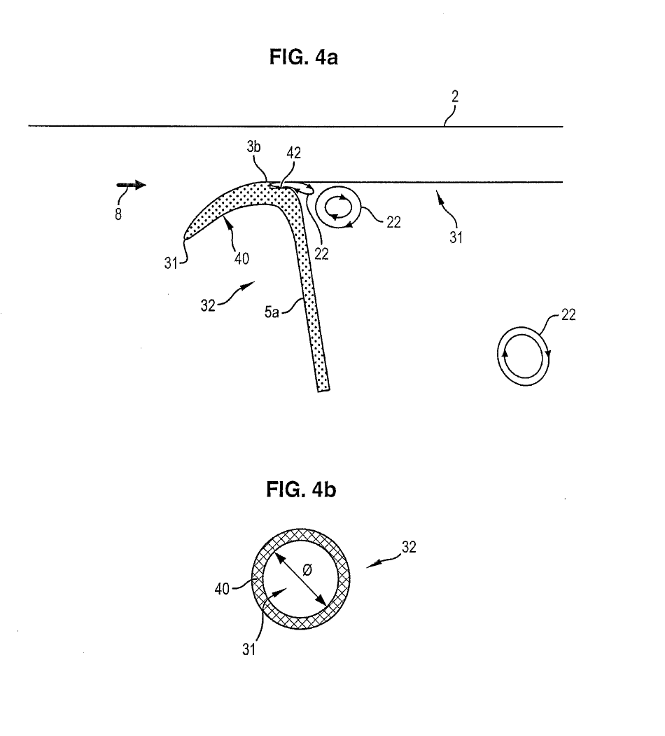

As shown in FIG. 4a, advantageously, the mouth can include a shoulder 42 located in the internal portion 31, able to form a vortex trap beyond the crest 3b, in the separation zone, in such a way that, when the hood is in operation, the vortices 22 remain inside the hood in relation to the wall 2, below the level of the crest 3b in relation to the wall 2.

As such, if particles are deposited at the mouth the vortices 22 do not repel the contaminated particles towards the exterior. The deposits of particles are also located on the shoulder 42, and can easily be cleaned during a later operation.

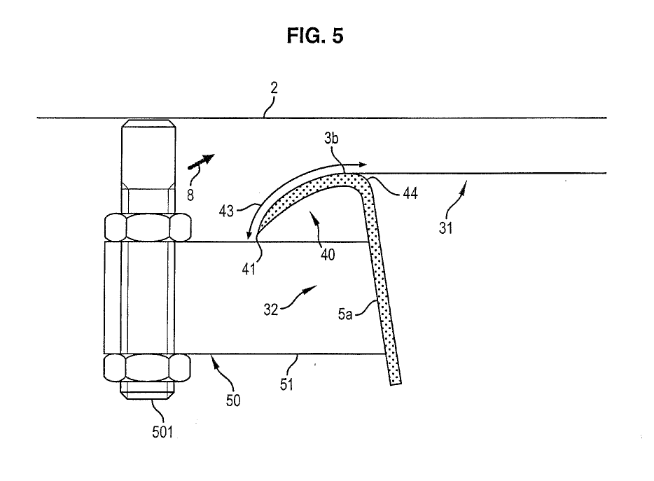

In order to be able to position the hood correctly in relation to the wall 2, the hood can include means 50 of positioning the hood in relation to the wall 2 (see FIG. 5).

These means 50 of positioning make it possible to adjust a distance between the crest 3b and the wall 2, in order to make it possible to adapt the input flow of air.

These means 50 can for example comprise screws 501 cooperating with a support 51 that is integral with the mouth 30, with the ends of the screws 501 abutting on the wall 2. These screws 501 are preferably located to the exterior, at a distance from the input lip 40 in the hood.

In accordance with FIG. 1, the hood can furthermore include a base 3a comprising a porthole 3 able to allow a laser beam 6 to pass through and an intermediary portion 5a between the mouth 3b and the base 3a.

The intermediary portion 5a of the hood is preferentially convergent between the mouth 3b and the base 3a.

By way of example, a hood can be carried out with the following dimensions:
Height of the hood 1: 450 mm;
Width of the base 3a: 160 mm;
Diameter O/ of the mouth 30 at the crest 3b: 360 mm;
Distance between the crest 3b and the wall 2: 10 mm;
Distance between the leading edge 41 of the lip 40 and the wall 2: 20 mm;
Length of the profile of the lip: 16 mm;
Flow of the sucked-up air: 60 litres per second;
Average air speed between the crest and the wall 2: 4 m/s.

1. A hood for sucking up fine particles, comprising
an air intake mouth comprising a crest intended to be arranged close to a wall able to emit fine particles, the crest defining an internal portion of the hood and an external portion; and
a suction outlet intended to suck up the fine particles;
wherein the mouth further comprises an external lip extending towards the suction outlet and comprising a leading edge located on the same side as the outlet in relation to the crest, in such a way that, when the hood is in operation, the sucked-up air undergoes no separation at the lip and that an air separation zone is located only in the internal portion of the hood and in that the mouth further comprises an internal shoulder able to form a vortex trap beyond the crest in the separation zone, in such a way that, when the hood is in operation, the vortices remain inside the hood in relation to the wall.

2. The hood according to claim 1, wherein, when the hood is in operation, the lip forms, in combination with the wall, a progressive convergent of the leading edge towards the crest.

3. The hood according to claim 1, wherein the lip has a curved profile, more preferably parabolic.

4. The hood according to claim 1, wherein the mouth comprises means of positioning the hood in relation to the wall in order to allow for the adjusting of a distance between the crest and the wall.

5. The hood according to claim 4, wherein the means of positioning comprises stop screws on the wall.

6. The hood according to claim 1, further comprising a base comprising a porthole able to allow a laser beam to pass through and an intermediary portion between the mouth and the base

7. Hood The hood according to claim 6, wherein the intermediary portion is convergent between the mouth and the base.

8. A device for the laser ablation of a surface layer of a wall comprising at least one laser source of ablation, wherein the device comprises a hood for sucking up fine particles according to claim 1.
